(19) United States
(12) Patent Application Publication
(10) Pub. No.: US 2006/0268366 A1
(43) Pub. Date: Nov. 30, 2006

(54) Method for Duplex Scanning and Generating Corresponding Images

(76) Inventor: Yen-Cheng Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/161,925

(22) Filed: Aug. 22, 2005

(30) Foreign Application Priority Data
May 24, 2005 (TW) 094116874

(51) Int. Cl. H04N 1/04

(52) U.S. Cl. 358/474

(57) ABSTRACT

A method for duplex scanning and generating corresponding images includes generating a first image by scanning a first side of a double-sided document, generating a second image by scanning a second side of the double-sided document, and eliminating background noise corresponding to the second side from the first image and background noise corresponding to the first side from the second image according to the first image and the second image.

### BACKGROUND OF THE INVENTION

1. Field of the Invention

The present invention relates to a method for duplex scanning and generating corresponding images, more particularly a method for scanning both sides of a double-sided document and updating at least one image according to both sides of the corresponding images.

2. Description of the Prior Art

A scanner is a common kind of computer peripheral. The scanner is utilized for scanning a document to generate corresponding data. The scanner then transforms the image data into digital data that can be stored in a computer. Once stored in the computer the digital data can be corrected and manipulated. Additionally, the scanner can provide features that are not considered to be transitional scanner features. For example, the scanner can fax image data to another fax device via a phone, the scanner can transmit an e-mail that is to contain some image data via a network, or the scanner can print the data via a printer. The development of a duplex scanner is an especially useful additional scanner function. The duplex scanner allows a user to scan both sides of a document simultaneously. This duplex operation reduces the time necessary for scanning thereby efficiently improving the scanning process. There are two types of duplex scanners. One type of duplex scanner is a scanner with dual scanning modules. The other type of duplex scanner is a scanner with only a single scanning module. The scanner with dual scanning modules utilizes top and bottom scanning modules to scan print images of both sides of a document simultaneously to obtain corresponding scan images of both sides of the document respectively. The scanner with a single scanning module usually comprises a more complicated document transmission sheet feed device that is necessary when the operation of duplex scanning is performed. In the case of a single scanning module, the scanning module is being controlled to scan a first side, and then utilizing the sheet feed device to flip the document so that a second reverse (i.e., back) side of the document can be scanned by the same single scanning module.

By eliminating the necessity of flipping a document (e.g., a document to be scanned), the duplex scanner provides convenience to the user. However, due to the translucence properties of a print medium (e.g., paper) a double-sided document, that is, a document paper with printed matter on both sides, will often show evidence of background noise being present in the scanned output resulting from the printed matter on the other side of the document. Please refer to FIG. 1 through FIG. 4. FIG. 1 illustrates a first side 12 diagram of a double-sided document 10. FIG. 2 illustrates a second side 14 diagram of a double-sided document 10. FIG. 3 illustrates a diagram of a first image 20 generated after a first side 12 is scanned. FIG. 4 illustrates a diagram of a second image 30 generated after a second side 14 is scanned. A first FIG. 16 and a second FIG. 18 are being printed onto the first side 12 and the second side 14 of the double-sided document 10 respectively. A first image 20 and a second image 30 corresponding to the first side 12 and the second side 14 are being generated respectively after the duplex scanner scans the double-sided document 10. In FIG. 3, it is obvious that the first image 20, other than having a first scan FIG. 26 corresponding to the first FIG. 16, also comprises a first background noise 28n that is caused by the second FIG. 18 on the second side 14; similarly, in FIG. 4 it is obvious that the second image 30, other than having a second scan FIG. 28 corresponding to the second FIG. 18, also comprises a second background noise 26n that is caused by the first FIG. 16 on the first side 12.

### SUMMARY OF THE INVENTION

Therefore, the main objective of the claimed invention is to provide a method for duplex scanning and generating corresponding images to solve the problem of background noise caused by images residing on a flip side of a document to be duplex scanned.

The method of the claimed invention comprising generating a first image by scanning a first side of a double-sided document, generating a second image by scanning a second side of the double-sided document, and updating a portion of the first image according to the first image and the second image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first side diagram of a double-sided document.

FIG. 2 illustrates a second side diagram of a double-sided document.

FIG. 3 illustrates a diagram of a first image generated after a first side is scanned.

FIG. 4 illustrates a diagram of a second image generated after a second side is scanned.

FIG. 5 illustrates a flowchart of a method according to the present invention.

FIG. 6 illustrates a flowchart of a first type of updating method for a first image.

FIG. 7 illustrates a flowchart of a first type of updating method for a second image.

FIG. 8 illustrates a flowchart of a second type of updating method for a first image.

FIG. 9 illustrates a flowchart of a second type of updating method for a second image.

### DETAILED DESCRIPTION

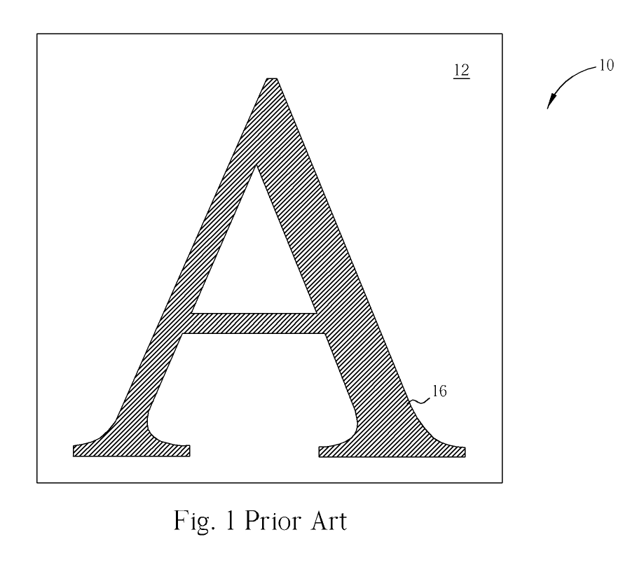

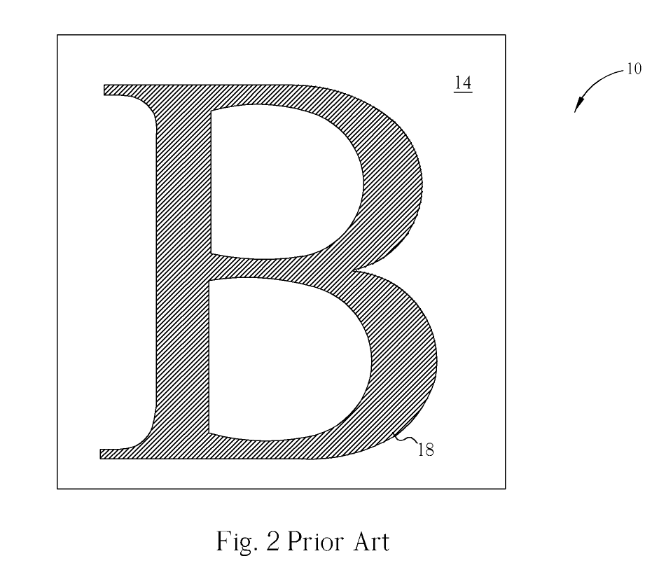

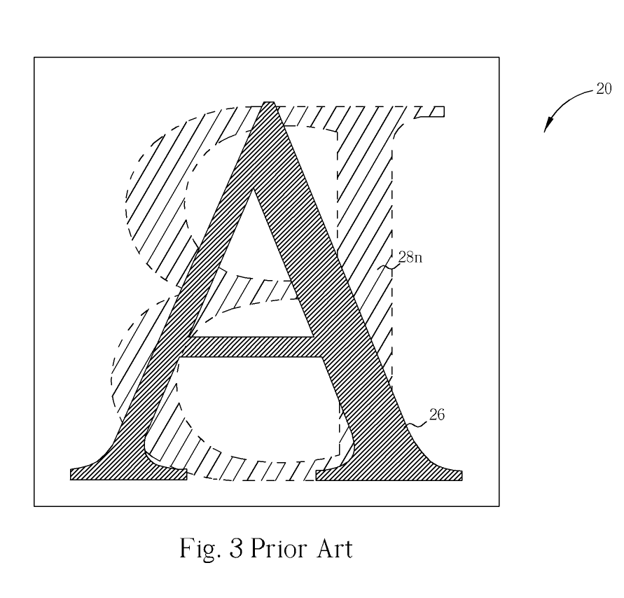

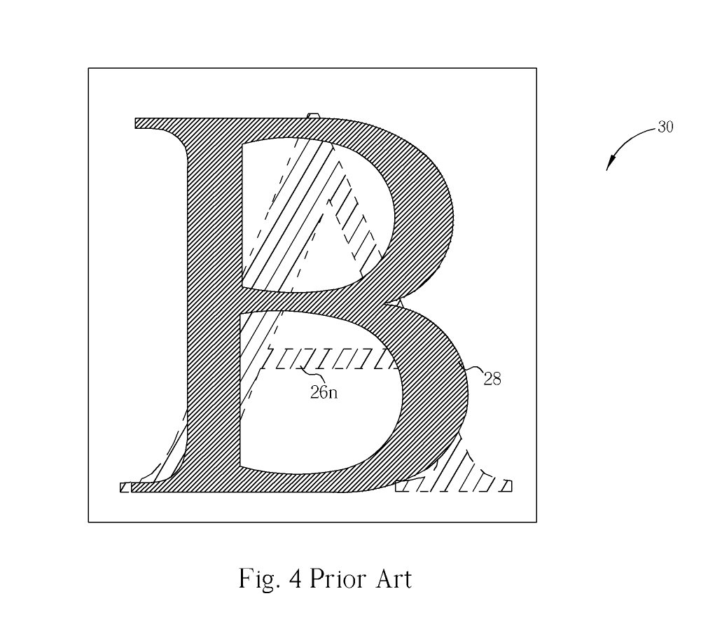

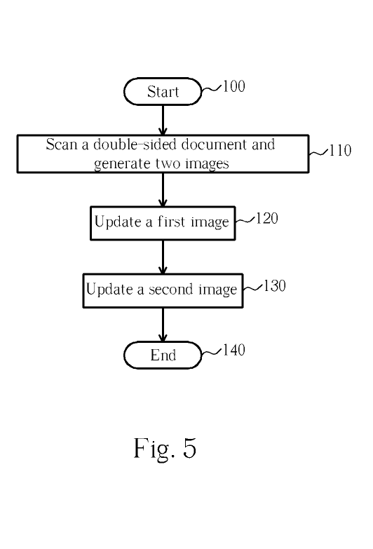

To reduce the problem of background noise in images generated using the conventional duplex scanning method, the present invention performs an updating action on the scanned images according to the double-sided images generated by the duplex scanner. The duplex scanner can perform the job of eliminating background noise automatically before the scanned images are outputted, the duplex scanner can also output to a computer the unedited scanned images with the background noise intact for eliminating background noise by a software. To further explain the characteristics of the present invention in the above mentioned, please refer to FIG. 1 through FIG. 5. FIG. 5 illustrates a flowchart of a method according to the present invention. The method of the present invention comprises the following steps:

Step 100: Start;

Step 110: Generate a first image 20 by scanning a first side 12 of a double-sided document 10, and generate a second image 30 by scanning a second side 14 of the double-sided document 10;

Step 120: Update a portion of the first image 20 according to the first image 20 and the second image 30;

Step 130: Update a portion of the second image 30 according to the first image 20 and the second image 30;

Step 140: End.

When step 120 is executed to detect a first background noise 28n according to the first image 20 and the second image 30, pixels corresponding to the first background noise 28n will be updated to a background color (e.g., white), and the pixel information of the first scan FIG. 26 will be retained, therefore the updated first image 20 will appear to be similar with the original first side 12 of the double-sided document 10. Similarly, when step 130 is executed to detect a second background noise 26n according to the first image 20 and the second image 30, pixels corresponding to the second background noise 26n will be updated to the background color (e.g., white), and the pixel information of the second scan FIG. 28 will be retained, therefore the updated second image 30 will appear to be similar to the original second side 14 of the double-sided document 10.

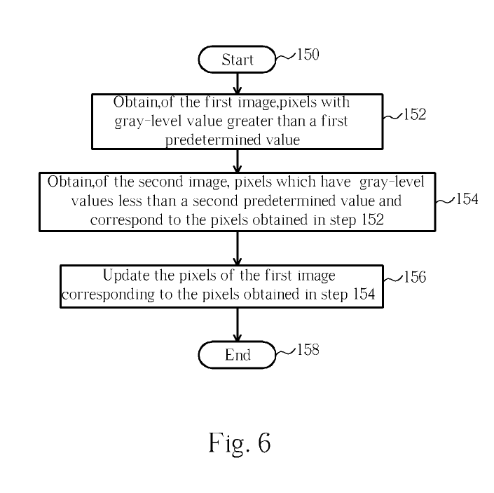

Further detailed explanation of step 120 describing how to detect the first background noise 28n according to the first image 20 and the second image 30 follows. Please refer to FIG. 6. FIG. 6 illustrates a flowchart of a first type of updating method for a first image 20. Firstly, it is determined which pixels of the first image 20 with gray-level values greater than a predetermined value (step 152), information of level of shading of each pixel can be obtained through the gray-level value of each pixel; and pixels of the scanned first image 20 can be analyzed to see which pixel is affected by the background noise through the level of shading of each pixel. Under normal circumstances, when the second FIG. 18 of the second side 14 is reflected through the paper to the first side 12, the display intensity tends to be weaker than the original display intensity on the second side 14. Furthermore, when a computer system records gray-level information of pixels, if the pixel is white then 255 is recorded, if the pixel is black then 0 is recorded, therefore when the black FIG. 18 of the second side 14 is reflected through the paper to the first side 12, gray-level value of pixel of the background noise reflected on the black FIG. 18 of the second side 14 will become greater. In short, the second FIG. 18 of a black letter B printed on the second side 14 reflected onto the first image 20 is the background noise image 28n of a gray reverse B gray (gray-level value is greater than 0). Therefore, pixels other than the first scan FIG. 26 can be found through step 152 to determine whether the pixels corresponding to pixels of the second image 30 are less than a second predetermined value (step 154). Step 154 is executed to find pixels of the second image 30 corresponding to pixels obtained in step 152 through a method of transformation of coordinates. The explanation of the method of transformation of coordinates is as follows: firstly, if dots per inch (dpi) of the first image 20 and the second image 30 is 200 pixels by 300 pixels, the coordinates of pixel at bottom left corner is (0, 0) and the coordinates of pixel at top right corner is (199, 299), when the method is performed, a pixel located at (X, Y) of the first image 20 corresponds with a pixel located at (199−X, Y) of the second image 30. Therefore pixels composing the second scan FIG. 28 can be found in the second image 30 through step 154. When step 156 is executed to find pixels of the first image 20 corresponding to pixels obtained in step 154 through the method of transformation of coordinates, the first background noise 28n in the first image 20 without pixels of the first scan FIG. 26 can be found, and gray-level values of the pixels will then be updated, usually gray-level of the pixels will be set to 255 (which is a white background). In conclusion, to the above-mentioned, after step 120 is executed, the first background noise 28n can be eliminated so that the first image 20 will appear to be identical to the first side 12 of the double-sided document 10.

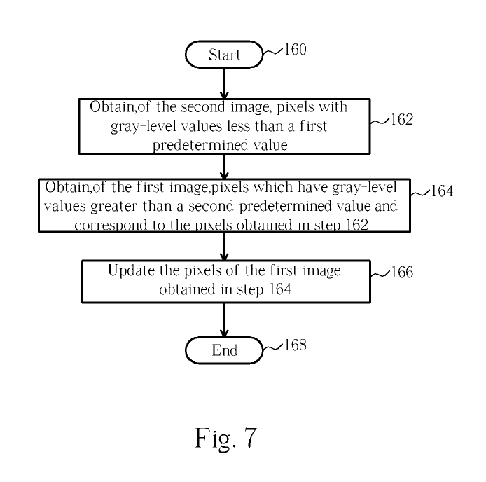

When step 130 is executed to update a portion of the second image 30 according the first image 20 and the second image 30, this flow is similar with the flow of updating a portion of the first image 20 in the above-mentioned. Please refer to FIG. 7. FIG. 7 illustrates a flowchart of a first type of updating method for a second image 30. Firstly, step 162 is executed (relative to step 152 in FIG. 6) to obtain pixels with gray-level values greater than the first predetermined value in the second image 30, at this time pixels other than pixels that constructed the second scan FIG. 28 are being captured. Step 164 is then executed (relative to step 154 in FIG. 6) to find pixels corresponding to the pixels in step 162 in the first image 20 and less than the second predetermined value, at this time all pixels that constructed the first scan FIG. 26 will be captured. Lastly when step 166 is executed (relative to step 156 in FIG. 6) to find and update pixels corresponding to the pixels in step 164 in the second image 30 so that the updated second image 30 will appear to be identical to the second side 14 of the double-sided document 10.

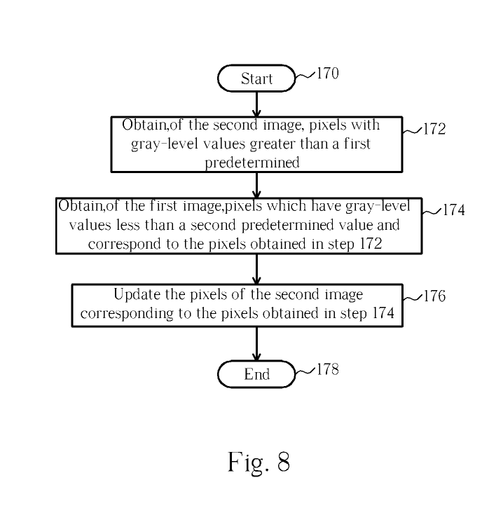

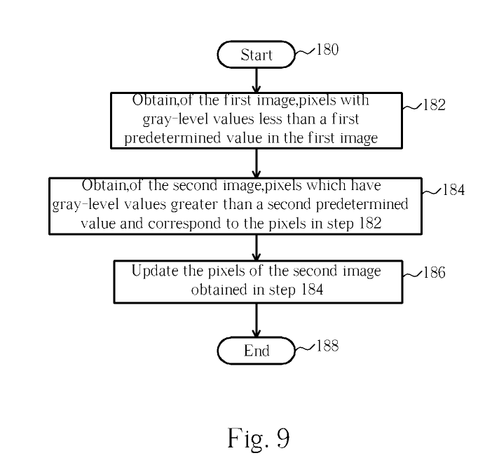

To further explain the change in sequence of obtaining pixels in step 152, 154 in FIG. 6., please refer to FIG. 8. FIG. 8 illustrates a flowchart of a second type of updating method for a first image 20. In the previous type of updating method the gray-level values of pixels in the first image 20 are first determined, specifically whether the gray-level values are greater than the first predetermined value (step 152) and then the pixels in the second image 30 corresponding to the first image 20 is determined, specifically whether the gray-level value is less than the second predetermined value (step 154), the present flow will first determine the gray-level values of pixels of the second image 30, specifically whether the gray-level values are less than the second predetermined value (step 172) and then the pixels in the first image 20 corresponding to the second image 30 is determined, specifically whether the gray-level value is less than the first predetermined value (step 174). After that, the first image noise 28n of the first image 20 can be eliminated through pixels obtained from step 174 (step 176). Similarly, the sequence of obtaining pixels in step 162, 164 in FIG. 7 can be changed. Please refer to FIG. 9. FIG. 9 illustrates a flowchart of a second type of updating method for a second image 30. In the previous type of updating method the second image 30, the gray-level values of pixels in the second image 30 are first determined, specifically whether the gray-level values are greater than the first predetermined value (step 162) and then the pixels in the first image 20 corresponding to the second image 30 is determined, specifically whether the gray-level values are less than the second predetermined value (step 164), the present flow will first determine the gray-level values of pixels of the first image 20, specifically whether the gray-level values are less than the second predetermined value (step 182) and then the pixels in the second image 30 corresponding to the first image 20 is determined, specifically whether the gray-level values are less than the first predetermined value (step 184). After that, the second image noise 26n of the second image 30 can be eliminated through pixels obtained from step 184 (step 186).

The method of eliminating the first image noise 28n and the second image noise 26n of the first image 20 and the second image 30 respectively is not only limited to the flows shown in FIG. 6 through FIG. 9. The method can also apply to two scan images generated by a duplex scan to achieve the motive of updating one of the scan images that is within the scope of the present invention. Furthermore, although the above-mentioned embodiment utilizes a black and white scan as an example, the present invention can be utilized on color scanners by processing each color of the RGB color information in a pixel. When the method of the present invention is utilized to eliminate the background noise of the original first image 20 and second image 30, the updated first image 20 and second image 30 are outputted.

In comparison to the prior art, the method of the present invention updates one of the scan images according to the double-sided scan images, the present invention not only achieves the objective of eliminating background noise but also increases the quality of scan images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for duplex scanning and generating corresponding images, the method comprising the following steps:
(a) generating a first image by scanning a first side of a double-sided document;
(b) generating a second image by scanning a second side of the double-sided document; and
(c) updating a portion of the first image according to the first image and the second image.

2. The method of claim 1 wherein step (c) further comprises the following steps:
(c1) obtaining, of the first image, pixels with gray-level values greater than a first predetermined value;
(c2) obtaining, of the second image, pixels which have gray-level values less than a second predetermined value and corresponding to the pixels obtained in step (c1); and
(c3) updating the pixels of the first image corresponding to the pixels obtained in step (c2).

3. The method of claim 1 wherein step (c) further comprises the following steps:
(c1) obtaining, of the second image, pixels with gray-level values less than a first predetermined value;
(c2) obtaining, of the first image, pixels which have gray-level values greater than a second predetermined value and corresponding to the pixels obtained in step (c1); and
(c3) updating the pixels of the first image obtained in step (c2).

4. The method of claim 1 further comprising the following step:
(d) outputting the updated first image.

5. The method of claim 1 further comprising the following step:
(d) updating a portion of the second image according to the first image and the second image.

6. The method of claim 5 wherein step (d) comprises the following steps:
(d1) obtaining, of the second image, pixels with gray-level values greater than a first predetermined value;
(d2) obtaining, of the first image, pixels which have gray-level values less than a second predetermined value and corresponding to the pixels obtained in step (d1); and
(d3) updating the pixels of the second image corresponding to the pixels obtained in step (d2).

7. The method of claim 5 wherein step (d) comprises the following steps:
(d1) obtaining, of the first image, pixels with gray-level values less than a first predetermined value;
(d2) obtaining, of the second image, pixels which have gray-level values greater than a second predetermined value and corresponding to the pixels in step (d1); and
(d3) updating the pixels of the second image obtained in step (d2).

8. The method of claim 5 further comprising the following step:
(e) outputting the updated second image.
